(19) United States
(12) Patent Application Publication
(10) Pub. No.: US 2007/0235683 A1
(43) Pub. Date: Oct. 11, 2007

(54) HEAT CONDUCTIVE SILICONE GREASE COMPOSITION

(75) Inventors: CHING-TAI CHENG, Tu-Cheng (TW); NIEN-TIEN CHENG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: FOXCONN TECHNOLOGY CO., LTD., Tu-Cheng (TW)

(21) Appl. No.: 11/309,365

(22) Filed: Aug. 1, 2006

(30) Foreign Application Priority Data
Apr. 5, 2006 (CN) 200610060185.0

(51) Int. Cl. C09K 5/00

(52) U.S. Cl. 252/71

(57) ABSTRACT

A heat conductive silicone grease composition is provided. The heat conductive silicone grease composition comprises: (A) a hydroxyl group-containing organopolysiloxane, and (B) a thermoconductive inorganic filler having an average particle size of 0.1˜10 micrometers.

### FIELD OF THE INVENTION

The present invention relates to a heat conductive silicone grease composition, and more specifically to a heat conductive silicone grease composition having an improved heat transfer ability for use with heat generating units.

### DESCRIPTION OF RELATED ART

With the continuing development of computer technology, electronic components such as central processing units (CPUs) of computers are being made to operate at higher operational speeds and to have greater functional capabilities. When a CPU operates at a high speed in a computer enclosure, its temperature increases rapidly. To avoid damage to the CPU, heat generated by the CPU must be dissipated quickly, which can be done by, for example, using a heat sink attached to a surface of the CPU contained in the enclosure. Dissipating the heat quickly allows the CPU and other high-performance electronic components contained in the enclosure to function within their normal operating temperature ranges, thereby assuring the quality of data management, storage and transfer of the CPU. Since the surface of CPU or the surface of heat sink is microscopically irregular despite apparent flatness, a thermal grease having a good heat transfer ability is employed between the CPU and the heat sink.

In the related art, the thermal grease is obtained by mixing a base oil (such as silicone oil or pentaerythritol oleate) and a thermoconductive inorganic filler. However, this kind of thermal grease suffers from the problem of oil bleeding during long-term service. As a result, it is not suitable for use directly between the CPU and the heat sink.

Therefore, an improved heat conductive silicone grease composition which can overcome the above problem is desired.

### SUMMARY OF THE INVENTION

A heat conductive silicone grease composition comprises the following components (A) and (B):

component (A): 100 parts by weight of a hydroxyl group-containing organopolysiloxane having at least two hydroxyl groups bonded directly to silicon atoms in a molecule thereof; and

component (B): 100˜2000 parts by weight of a highly thermoconductive inorganic filler.

Other advantages and novel features of the present invention can be drawn from the following detailed description of a preferred embodiment of the present invention, in which:

### DETAILED DESCRIPTION OF THE INVENTION

According to an embodiment of the present invention, the heat conductive silicone grease composition includes the following components: (A) an organopolysiloxane, and (B) a filler.

The organopolysiloxane of component (A) is a hydroxyl group-containing organopolysiloxane having at least two hydroxyl groups in a molecule thereof, each of the hydroxyl groups being directly bonded to a silicon atom. The organopolysiloxane may be either straight or branched. A mixture of two or more organopolysiloxanes having different viscosities is acceptable. The preferred embodiment of other side group bonded to the silicon atom of the hydroxyl group-containing organopolysiloxane is methyl, ethyl, propyl, or butyl et al. Component (A) should preferably have a viscosity in the range of 100 to 100,000 mm²/s at 25° C. A preferred embodiment of component (A) is represented by the following general formula:

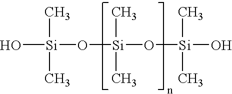

wherein n is an integer from 5 to 10. The amount of component (A) is 100 parts by weight.

The filler component (B) is used to raise the thermal conductivity of the composition. The filler is a highly thermoconductive inorganic filler selected from aluminum powder, zinc oxide powder, aluminum nitride powder, boron nitride powder et al, or any suitable combination of the foregoing materials. The mean particle size of the filler directly effects the viscosity of the composition; for this reason, the filler used herein preferably has a mean particle size of 0.1 to 10 μm. The preferred embodiment of component (B) is an aluminum powder having a mean particle size of 0.1 to 10 μm, a zinc oxide powder having a mean particle size of 0.1 to 10 μm, or a mixture of an aluminum powder having a mean particle size of 0.1 to 10 μm and a zinc oxide powder having a mean particle size of 0.1 to 5.0 μm. The filler of component (B) is able to react with the hydroxyl groups in component (A) to form a chemical bond to thereby enhance stability of the composition and prevent oil bleeding during long-term use of the composition. The amount of component (B) is 100 to 2000 parts by weight.

The heat conductive silicone grease composition of the present invention is obtained by mixing components (A) and (B) at room temperature.

In use, the heat conductive silicone grease composition is applied between a heat generating unit such as a CPU and a heat sink, and the composition is located and compressed between the heat generating unit and the heat sink, and completely fills gaps formed between the heat generating unit and the heat sink to increase thermal contact surface area between the heat generating unit and the heat sink. The composition being applied should preferably have a thickness in the range of 10˜100 μm.

The reactivity of component (A) with component (B) increases with the increase of the temperature of the heat generating unit to thereby enhance the stability of the composition and prevent oil bleeding from happening during long-term use of the composition.

### EXAMPLE

The present invention is now specifically described with reference to an example whose components are given below:

component (A): a hydroxyl group-containing organopolysiloxane, represented by the following general formula:

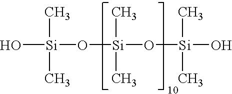

component (B): an aluminum powder having a mean particle size of 2 μm.

In this example, the composition was prepared by adding component (A) and component (B) in proportions shown in Table 1, mixing at room temperature, and thereby obtaining the composition.

Next, the thermal resistance of the composition was measured according to ASTM D-5470 standards. The composition was sandwiched between two standard copper plates under a pressure of approximately 1.8 kg/cm2, and was then kept at 25° C. for 30 days to check for oil-bleeding. The results of the measurement test are shown in Table 1.

TABLE 1

| | Example |
|---|---|
| Hydroxyl group-containing Organopolysiloxane | 50 vol % |
| Aluminum Powder (2 μm) | 50 vol % |
| Heat Resistance (K · cm²/W) | 0.254 |
| After 30 days at 75° C., was oil-bleeding detected? | NO |

### Comparative Examples

Comparative compositions were prepared in an identical manner to that of the example of the present invention using the components shown in Table 2. The thermal resistance of each of the comparative compositions was measured according to ASTM D-5470 standard, and the results of the measurement test are shown in Table 2.

TABLE 2

| | Comparative Examples | | |
|---|---|---|---|
| | 1 | 2 | 3 |
| Pentaerythritol oleate | 50 vol % | 55 vol % | 65 vol % |
| Aluminum Powder (2 μm) | 50 vol % | | |
| Aluminum and Zinc oxide | | 45 vol % | |
| Powder (2 μm) | | | |
| Zinc oxide Powder (2 μm) | | | 35 vol % |
| Heat Resistance (K · cm²/W) | 0.231 | 0.247 | 0.252 |
| After 30 days at 75° C., was oil- | YES | YES | YES |
| bleeding detected? | | | |

The results of Table 1 and Table 2 show that the composition of the present invention has better heat stability, and prevents oil bleeding during long-term use.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A heat conductive silicone grease composition comprising:
component (A): 100 parts by weight of a hydroxyl group-containing organopolysiloxane having at least two hydroxyl groups bonded directly to silicon atoms in a molecule thereof; and
component (B): 100˜2000 parts by weight of a highly thermoconductive inorganic filler.

2. The composition according to claim 1, wherein the component (A) has a viscosity of 100˜100,000 mm²/s at 25° C.

3. The composition according to claim 1, wherein the component (A) is represented by the following general formula: 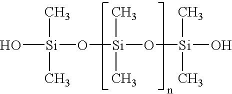
wherein n is an integer from 5 to 10.

4. The composition according to claim 3, wherein the n is an integer of 10.

5. The composition according to claim 4, wherein the component (B) is selected from one of an aluminum powder having a mean particle size of 0.1 to 10 μm, a zinc oxide powder having a mean particle size of 0.1 to 10 μm, and a mixture of an aluminum powder having a mean particle size of 0.1 to 10 μm and a zinc oxide powder having a mean particle size of 0.1 to 5 μm.

6. The composition according to claim 5, wherein the component (B) is an aluminum powder having a mean particle size of 2 μm.

7. The composition according to claim 1, wherein the component (B) is selected from one of an aluminum powder having a mean particle size of 0.1 to 10 μm, a zinc oxide powder having a mean particle size of 0.1 to 10 μm, and a mixture of an aluminum powder having a mean particle size of 0.1 to 10 μm and a zinc oxide powder having a mean particle size of 0.1 to 5 μm.
